(19) United States
(12) Patent Application Publication
(10) Pub. No.: US 2006/0097601 A1
(43) Pub. Date: May 11, 2006

(54) Rotor arrangement for an electric machine and a method for the manufacture of a rotor arrangement

(76) Inventor: Willi Hauger, Villingen-Schwenningen (DE)

Correspondence Address: Mark C. Comtois;DUANE MORRIS LLP, Suite 700, 1667 K Street, N.W., Washington, DC, 20006, US

(21) Appl. No.: 11/266,263

(22) Filed: Nov. 4, 2005

(30) Foreign Application Priority Data
Nov. 10, 2004 (DE) 10 2004 054 277.5

(51) Int. Cl. H02K 1/06

(52) U.S. Cl. 310/217

(57) ABSTRACT

A rotor arrangement for an electric machine having a substantially cylindrical rotor body and a shaft on which the rotor body is mounted, wherein the rotor body is divided into a plurality of substantially identical rotor sections in at least one plane containing the axis of the shaft, and wherein the circumference of the shaft has at least one region to receive the rotor sections and the rotor sections are connected to the shaft in a positive fit in this region.

### FIELD OF THE INVENTION

The invention relates to a rotor arrangement for an electric machine and a method for the manufacture of a rotor arrangement. The rotor arrangement according to the invention can be employed in various types of electric machines, such as DC motors and generators.

### BACKGROUND OF THE INVENTION

A preferred field of application for the invention is in brushless DC motors and other permanent magnet motors. In such motors, it is basically known to provide permanent magnets on the circumference of a rotor back yoke or to embed them in the back yoke. The invention can be particularly employed in electric motors and generators that are configured as inner rotor motors. Electric motors having an inner rotor configuration have a rotor back yoke that is mounted onto a shaft and one or more permanent magnets that are mounted onto the rotor back yoke or embedded in the back yoke. The motors additionally comprise a stator arrangement consisting, for example, of a number of stacked metal laminations which form an annular stator back yoke from which pole shoes protrude inwards. Phase windings are mounted on the pole shoes. The rotor arrangement is inserted coaxially into the stator arrangement.

FIG. 6 shows the basic construction of an electric motor having a housing 100 in which a stator arrangement 112, a rotor arrangement 114 and bearings 116, 118 to rotatably support the rotor arrangement are accommodated. The stator arrangement 112 comprises stacked metal laminations 120 and windings 122 and defines an inner space into which the rotor arrangement 114 is inserted. The rotor arrangement 114 includes the shaft 126, an iron back yoke 128 and permanent magnets 130. The bearings 116, 118 supporting the rotor arrangement can be integrated into a flange 132 of the motor housing 100. FIG. 6 serves to explain the basic construction of an electric motor. As mentioned at the outset, in its preferred application, the invention relates to a rotor back yoke for a brushless DC motor, the permanent magnets being embedded in the rotor back yoke.

Rotors having embedded magnets are generally known in the prior art. A rotor configuration having a multi-polar, spoke-like arrangement of radially extending embedded magnets is shown, for example, in EP 0 691 727 A1. This document shows a number of permanent magnets which are inserted into slits formed in the rotor body allowing the permanent magnets to be inserted into the rotor body from the outside.

In the prior art, a rotor body or rotor back yoke to receive the permanent magnets is frequently formed from a stack or packet of stamped and packed laminations, each back yoke lamination being substantially annular and having recesses to receive the permanent magnets. As a rule, the rotor body is mounted onto a shaft in a pressfit, with or without knife edges. It is also known to injection-mold the rotor body and the shaft with plastics in a positive fit.

The problem arising in the manufacture of this kind of rotor back yoke is that in punching out the individual back yoke laminations there is considerable waste. What is more, depending on the design of the rotor body, particularly in the case of rotors having embedded permanent magnets, the inner ring of the rotor body can be so thin that there is not enough space or material volume to reliably take up the forces prevailing in an interference fit between the rotor body and the shaft.

It is the object of the present invention to provide a rotor arrangement for an electric machine which avoids the above-mentioned disadvantages and can not only be manufactured in a material-saving way but can also be reliably mounted onto a shaft.

### SUMMARY OF THE INVENTION

This object has been achieved by a rotor arrangement having the characteristics outlined in claim 1 as well as by a method according to claim 14.

The invention provides a rotor arrangement for an electric machine and particularly for a brushless DC motor having an inner rotor configuration that has a substantially cylindrical rotor body which is mounted onto a shaft. According to the invention, the rotor body is divided into several identical or substantially identical rotor sections in at least one plane containing the axis of the shaft. In the preferred embodiment of the invention these rotor sections are semi-cylindrical; referred to below as “rotor halves”. The rotor sections or rotor halves are slid sideways onto the shaft and fitted together on the shaft. To create a positive fit between the shaft and the rotor body, the shaft is preferably polygonal, for example square, in at least one region in which it receives the rotor sections, so that in this region the rotor sections are connected to the shaft in a positive fit. The rotor body is thus formed from at least two rotor halves that together define a central aperture which engages with the shaft in a positive fit. Using the positive-fit connection instead of the conventional frictionally engaged connection found in the prior art makes it possible not only to create a more robust connection between the rotor body and the shaft without increasing the size of the shaft diameter, but also to improve the transfer of torque. Stability problems arising when the rotor is pressed onto the shaft, which occur in the prior art particularly in conjunction with small motors, can be avoided. The rotor body is built up of a plurality of rotor sections and can thus be made of laminations that can be punched out with less waste, since what is needed is a large number of smaller laminations that are substantially identical in design.

Whereas in the preferred embodiment of the invention, the rotor body is made up of at least one pair of semi-cylindrical rotor halves, it can also be provided for the rotor body to be divided longitudinally in several axial planes, for example, in three one-third cylinders or four quarter cylinders.

In a preferred embodiment of the invention, the rotor body is additionally divided into a plurality of rotor section groups in at least one radial plane. Adjacent rotor section groups are mounted onto the shaft offset at an angle with respect to one another. It can be provided, for example, for one, two or thee rotor section groups, in particular rotor-half pairs, to be arranged next to one another along the length of the shaft, the rotor sections of one group (or the rotor halves of a pair) being offset with respect to the adjoining group in order to achieve a more even distribution of the rolling direction of the rotor laminations.

Provision can also be made for the rotor body to be built up of a large number of individual rotor lamination sections that are disposed next to each other along the shaft and mounted on the shaft offset at an angle with respect to one another. In the preferred design of this embodiment, the individual rotor lamination sections are semi-circular in shape, referred to below as “rotor lamination halves”, with adjoining rotor lamination-half pairs being preferably offset with respect to one another at an angle of 90 degrees.

Although it was mentioned above that the shaft is preferably square in the region in which it receives the rotor sections, for the purposes of the invention any polygon is suitable, particularly any equilateral polygon such as a triangle, octahedron, tetrahedron etc. The rotor sections have a central aperture which can form a positive-fit connection with the shaft. If the rotor body is built up of a plurality of rotor section groups or rotor-half pairs respectively, provision can also be made for the rotor body and the shaft to be connected in a positive fit only in the region of one these groups or one of these pairs.

In the rotor arrangement according to the invention, provision is made for the permanent magnets to be embedded, which means that the rotor body has appropriate recesses to receive the permanent magnets.

After the rotor sections have been connected to the shaft, they can be held together by means of end caps, a sleeve which is slid over the rotor body, one or more clamping rings or suchlike. These means of connection may, for example, be pressed onto the rotor body.

The rotor body is preferably made from a ferromagnetic material and forms a rotor back yoke. Where appropriate permanent magnets are used that do not require a back yoke, such as in the case of Halbach magnetization, the rotor body can also be made of a non-magnetic material. It is preferable, however, if it is built up of ferromagnetic laminations.

The invention also provides a method for the manufacture of a rotor arrangement for an electric machine. In this method, rotor laminations to form a substantially cylindrical rotor body are stamped out in such a way that they are divided into a plurality of rotor lamination sections in at least one plane containing the axis of the shaft. The rotor lamination sections are connected to the shaft in a positive fit, the shaft being preferably polygonal, for example square, in at least one region used to receive the rotor lamination sections. The rotor lamination sections are preferably fitted together to form packed lamination stacks before they are connected to the shaft. However, it is also possible to mount individual rotor lamination halves or rotor lamination sections onto the shaft and to join them together only after all rotor laminations have been mounted.

### BRIEF DESCRIPTION OF DRAWINGS

The invention is described in more detail below on the basis of preferred embodiments with reference to the drawings. The figures show:

FIG. 1a a perspective, exploded view of a rotor arrangement according to a first embodiment of the invention;

FIG. 1b the rotor arrangement of FIG. 1a in an assembled state;

FIG. 2a a perspective, exploded view of a rotor arrangement according to a second embodiment of the invention;

FIG. 2b the rotor arrangement of FIG. 2a in an assembled state;

FIG. 3a a perspective, exploded view of a rotor arrangement according to a third embodiment of the invention;

FIG. 3b the rotor arrangement of FIG. 3a in an assembled state;

FIG. 4a a perspective, exploded view of a rotor arrangement according to a fourth embodiment of the invention;

FIG. 4b the rotor arrangement of FIG. 4a in an assembled state;

FIG. 5 a perspective view to explain a rotor arrangement according to a fifth embodiment of the invention and

FIG. 6 a schematic view of an electric motor in which the rotor arrangement according to the invention can be employed.

### DESCRIPTION OF PREFERRED EMBODIMENT

In the embodiments described below, the rotor body of the rotor arrangement according to the invention forms a magnetic back yoke and is built up of magnetically active (ferromagnetic) metal laminations. A person skilled in the art, however, would be aware that the basic principles of the present invention could also be applied to a non-magnetic rotor body which is not made up of individual laminations and/or made of another material. If, for example, magnets having Halbach magnetization, which do not need a magnetic back yoke, are used the rotor body can also be made from plastics, such as injection-molded plastics.

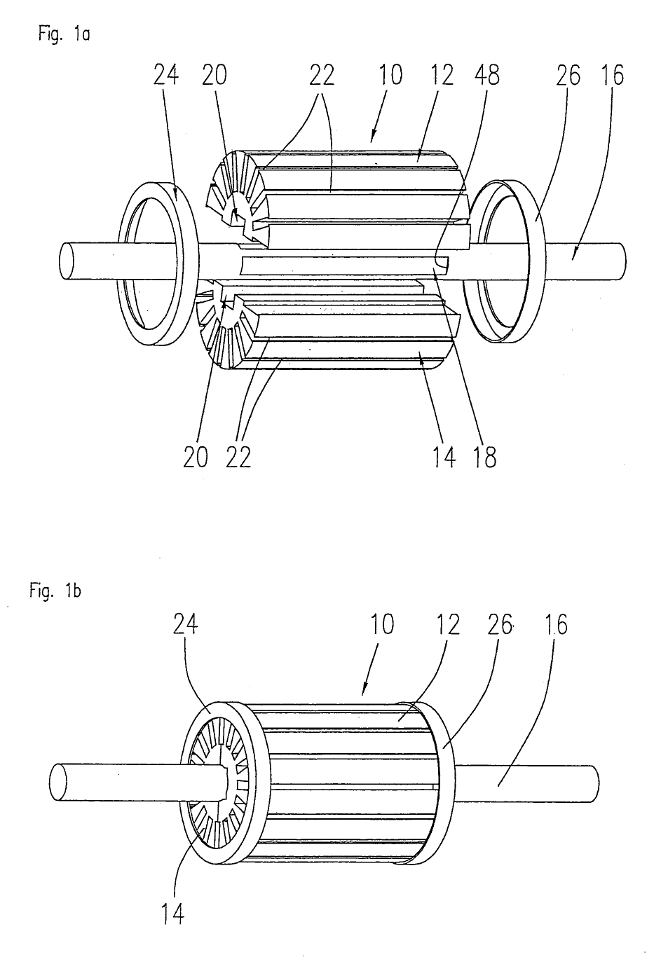

FIGS. 1a and 1b show a rotor arrangement according to a first embodiment of the invention in an exploded and an assembled view respectively. In the first and most simple embodiment of the invention a rotor body 10 is built up of two halves 12, 14 that form rotor sections and are placed against each other on a shaft 16. In the illustrated embodiment, the shaft 16 has a square cross-section in a region 18 in which the rotor sections 12, 14 are mounted. The region 18 could take the form of any other polygon so desired, but preferably the form of an equilateral polygon. It can be seen from the figure, that a polygonal cross-section of the shaft also includes such cross-sections in which the corners of the polygon lie outside the diameter of the shaft, so that the corners of the polygon are cut by the circumference of the shaft. The region 18 can be made by machining a shaft 16 that in itself is round, the polygonal cross-section being preferably machined into the shaft and not larger than the original shaft. Examples of machining techniques to form the polygonal region 18 include material-removing manufacturing processes and cold forming techniques. Since the polygonal cross-section is formed in the shaft, it not only ensures that the shaft is connected to the rotor body in a positive fit but also allows the rotor body to be axially positioned on the shaft by having positive-fit shoulders 48 formed at the axial ends of the region 18.

Together, the rotor sections 12, 14 define a central aperture 20 in the rotor body whose shape is adapted to the profile of the region 18 in order to connect the rotor sections 12, 14 to the shaft 16 in a positive fit.

In the illustrated embodiment, the rotor sections 12, 14 have slots 22 to receive permanent magnets which are embedded in the rotor body 10. The rotor sections 12, 14 are preferably built up as lamination stacks, the approximately semi-circular laminations first being joined to form a rotor-half 12 or 14 and then mounted onto the shaft 16. After the rotor body 10 has been assembled on the shaft 16, in the illustrated embodiment, it is held together by end caps 24, 26. These can be simply slid or pressed onto the end faces of the rotor body 10 and bonded to the rotor body. Care should be taken here to ensure that the end caps 24, 26 are placed in a magnetically non-critical region of the rotor arrangement.

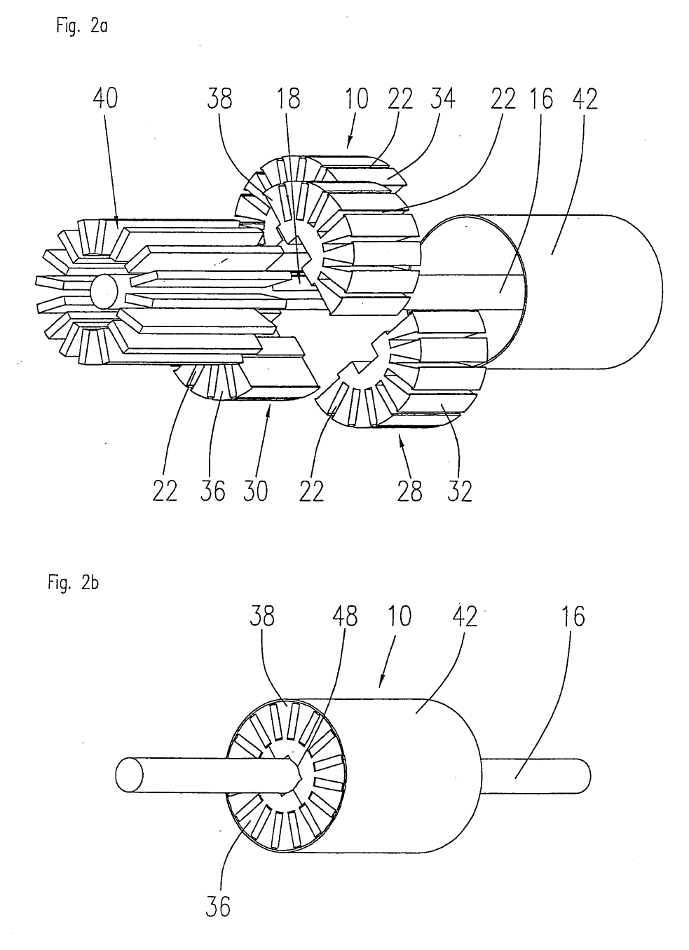

FIGS. 2a and 2b show another embodiment of the rotor arrangement according to the invention. In the embodiment illustrated in FIGS. 2a and 2b, the rotor body 10 is made up of two groups 28, 30 of rotor sections 32, 34, 36, 38, or more precisely of two pairs of rotor halves. While the rotor halves 32, 34, 36, 38 of a pair 28 or 30 are distributed along a plane containing the axis of the shaft, the two pairs 28, 30 are separated by a radial plane. The rotor halves 32, 34 and 36, 38 of adjoining pairs 28, 30 are mounted onto the shaft 16 offset at an angle. In the illustrated embodiment, each pair 28, 30 is formed by two rotor halves 32, 34 and 36, 38, the rotor halves 32, 34 of one pair 28 being offset with respect to the rotor halves 36, 38 of the other pair 30 by approximately 90 degrees. Provision can also be made for more than two rotor sections, for example three or four rotor sections, to be provided within each group. Should this be the case, adjoining groups are offset with respect to one another at a correspondingly smaller angle.

As in the embodiment of FIGS. 1a and 1b, the shaft 16 is given a square or polygonal cross-section in the region in which it receives rotor sections 32 to 38. Rotor sections 32, 34 and 36, 38 are thus mounted against each other on the shaft 16 in a positive fit.

As in the embodiment of FIGS. 1a and 1b, the rotor sections have slots 22 to receive permanent magnets. The permanent magnets 40 are slid into the slots 22 in an axial direction after the rotor sections 32 to 38 have been mounted onto the shaft 16. The rotor body 10 thus assembled is held together by a sleeve 42, which can be slid or pressed onto the rotor body 10 in an axial direction.

The rotor sections 32, 34 and 36, 38 of the two groups 28, 30 are made up of lamination stacks and are preferably disposed on the shaft 16 at an offset of 90 degrees with respect to each other, in order to compensate the preferred magnetic direction of the lamination stack and to avoid as far as possible magnetic asymmetries caused by the rolling process and also due to joints within each rotor section group.

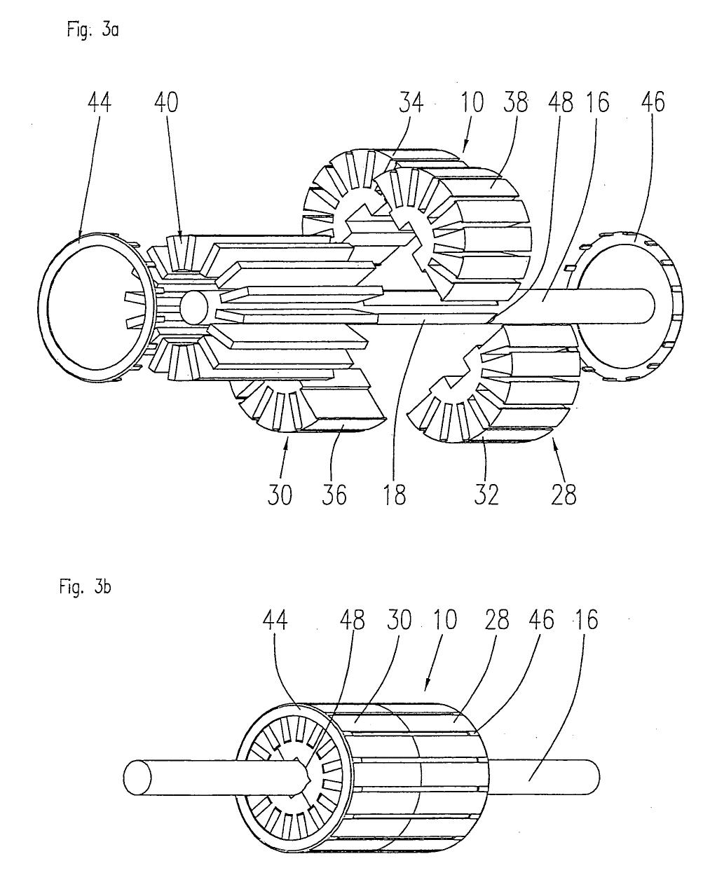

FIGS. 3a and 3b show another embodiment of the rotor arrangement according to the invention which is largely identical to the embodiment of FIGS. 2a and 2b, with finger end caps 44, 46 being used, however, instead of the sleeve 42 to connect the rotor body 10.

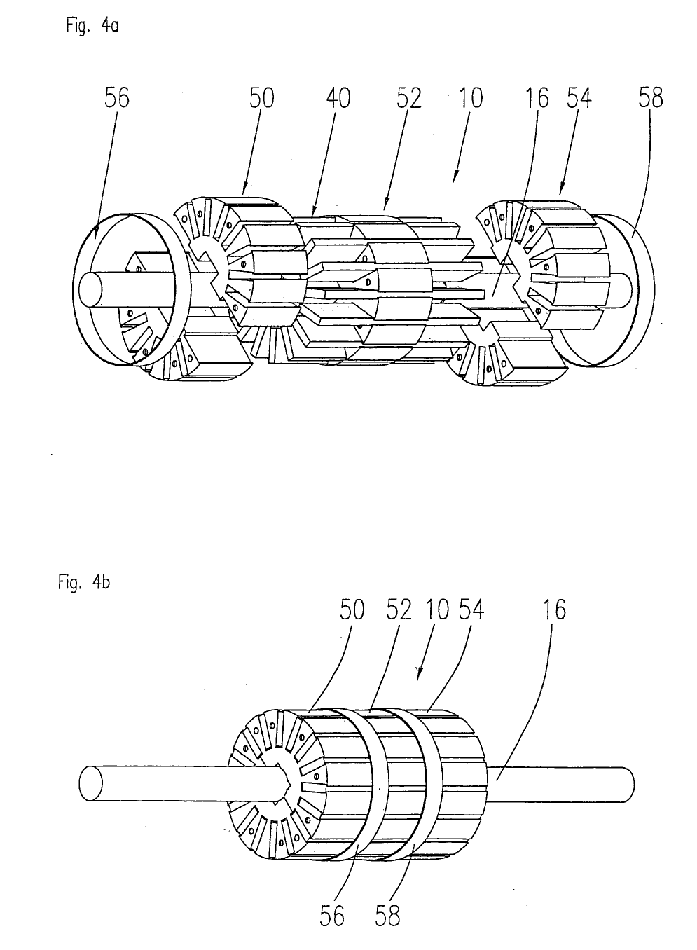

FIGS. 4a and 4b show another embodiment of the rotor arrangement according to the invention. In this embodiment, the rotor body is built up of three rotor-half pairs 50, 52, 54. Each rotor-half pair 50, 52, 54 consists of two rotor sections or rotor halves which are mounted against each other on the shaft 16. As in FIGS. 1a to 3b, the shaft has a region with a polygonal cross-section, this region extending at least over the axial length of the middle rotor-half pair 52, preferably however over the axial length of all rotor-half pairs 50 to 54. The two outer rotor-half pairs 50, 54 are arranged in such a way that they are flush with each other and offset with respect to the middle rotor-half pair 52 by an angle of 90 degrees. This symmetric arrangement makes it easier to insert the permanent magnets 40 into the slots in the rotor sections or rotor halves as the risk of tilting and jamming the magnets between the rotor-half pairs 50, 52, 54 is minimized.

The rotor arrangement 10 shown in FIG. 4a is held together by clamping rings 56, 58 after the rotor-half pairs 50 to 54 have been mounted onto the shaft 16 and the permanent magnets 40 have been inserted. Like the sleeve 42 in FIGS. 2a and 2b, the clamping rings can be pressed onto the rotor body 10.

As in the preceding embodiments, in the embodiment of FIGS. 4a and 4b, all rotor sections or rotor halves have the same geometric shape and can be made from identical sheet-metal blanks. The only situation in which this principle is deviated from is when only one of the rotor-half pairs, preferably the middle rotor-half pair 52, is connected to the shaft 16 in a positive fit, with the shaft 16 remaining round in the region of the two other rotor-half pairs.

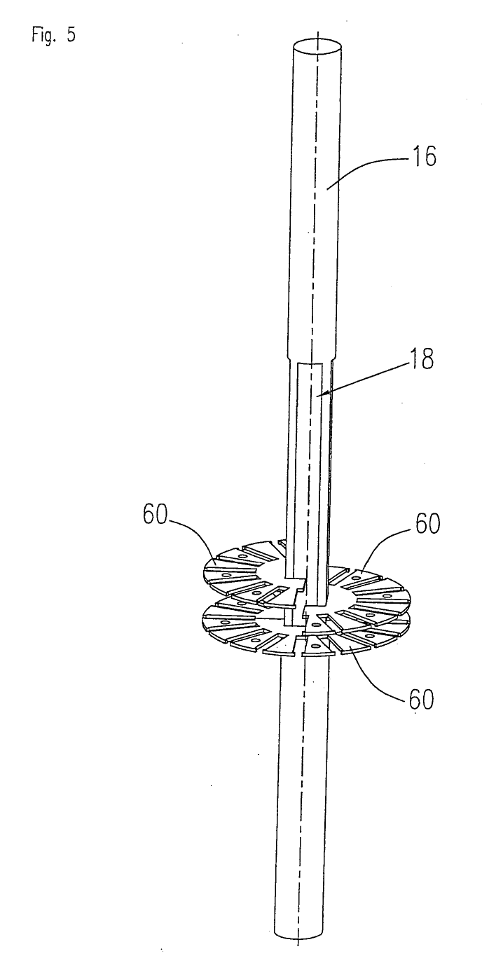

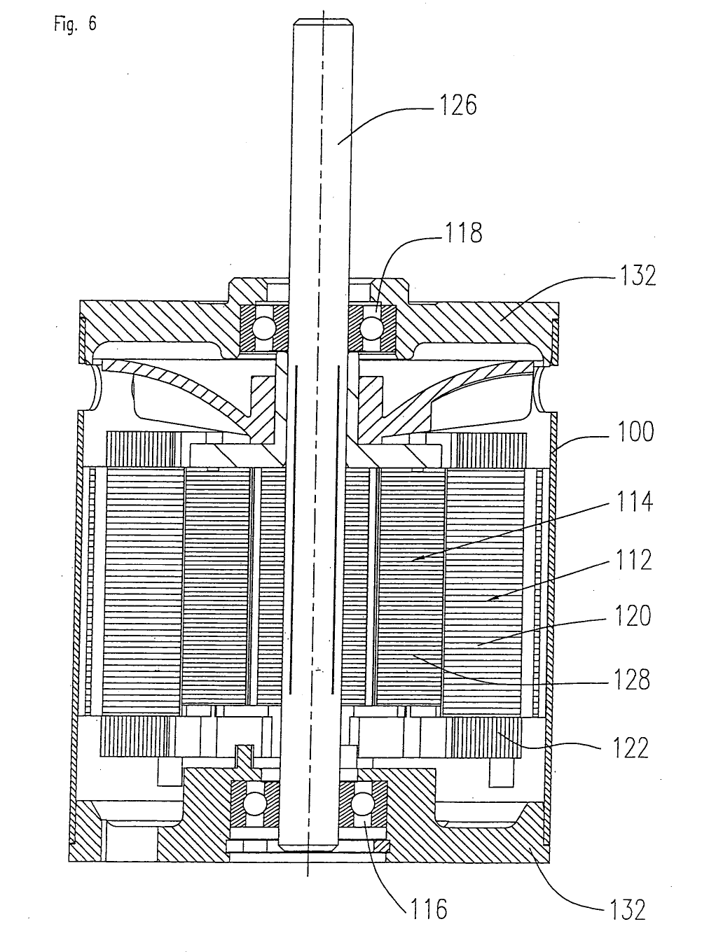

Another embodiment of the invention is finally shown in FIG. 5. FIG. 5 shows the shaft 16 with a square cross-section in region 18 used to mount the rotor sections. In the embodiment of FIG. 5, the rotor body 10 is built up of individual rotor laminations 60 which are mounted, stacked and joined together as rotor lamination-half pairs on the shaft 16 in region 18. Here, one rotor lamination-half pair is offset with respect to the adjoining rotor lamination-half pair preferably by an angle of 90 degrees. The rotor laminations 60 can be joined using the same method as in a conventional lamination stacking process by latching, pressing or suchlike.

In the embodiment of FIG. 5, each rotor lamination-half pair 60 substantially takes the form of a semi-circle having slots for the insertion of the permanent magnets and a central aperture which is adapted to the cross-section of the shaft 16 in region 18. To this extent, each rotor lamination-half pair, formed from two rotor lamination halves 60, corresponds to one of the rotor sections or rotor halves of the preceding embodiments. Just as in the preceding embodiments, it is possible to divide the rotor body along several axial planes in a plurality of identical rotor lamination sections which are joined together on the shaft 16.

In each of the preferred embodiments, the rotor body is built up of one or more lamination stacks. In contrast to the embodiment of FIG. 5, however, it is preferable if several laminations are first joined together to form a rotor section and the rotor sections subsequently fitted together on the shaft 16.

In the embodiment of FIG. 5, it is expedient if the rotor body built up of the rotor lamination halves 60 is held together by a sleeve (not illustrated) after the permanent magnets have been inserted. The half-laminations offset with respect to each other by an angle of 90° are preferably pressed or latched together.

The invention provides a reliable connection and good torque transfer between the rotor and the shaft even in the case of small motors where to date a pressfit has proved problematic. This is achieved by a positive-fit between the rotor and the shaft in that the shaft is given a polygon shape in the region in which the rotor body is mounted.

Thanks to the multi-part construction of the rotor body, the laminations needed to form the rotor body can be punched out with little material waste.

The sleeves, clamping rings or end caps used to connect and hold the rotor body together can be pressed or shrunk onto the rotor body. They can be made of a magnetic or non-magnetic material such as aluminum, plastics or stainless steel. In addition or as an alternative, it is also possible to injection-mold the entire rotor with plastics. The magnets can be bonded in the rotor body and the rotor sections of a group or rotor halves of a pair could also first be held together by bonding.

The features disclosed in the above description, the claims and the figures can be important for the realization of the invention in its various embodiments both individually and in any combination whatsoever.

### Identification Reference List

10 Rotor body
12, 14 Rotor sections, rotor halves
16 Shaft
18 Region having a square cross-section
20 Central aperture
22 Slots, recesses
24, 26 End caps
28, 30 Groups, pairs
32, 34, 36, 38 Rotor sections, rotor halves
40 Permanent magnets
42 Sleeve
44, 46 Finger end caps
48 Positive-fit shoulders
50, 52, 54 Rotor-half pairs
56, 58 Clamping ring
60 Rotor lamination halves
100 Housing
112 Stator arrangement
114 Rotor arrangement
116, 118 Bearings
120 Metal laminations
122 Windings
126 Shaft
128 Back yoke
130 Permanent magnets
132 Flange

1. A rotor arrangement for an electric machine comprising a substantially cylindrical rotor body (10) and a shaft (16) on which the rotor body (10) is mounted, wherein the rotor body (10) is divided into a plurality of substantially identical rotor sections (12, 14; 32, 34, 36, 38; 60) in at least one plane containing the axis of the shaft, and wherein the circumference of the shaft (16) has at least one region (18) to receive the rotor sections and the rotor sections (12, 14; 32, 34, 36, 38; 60) are connected to the shaft (16) in a positive fit.

2. A rotor arrangement according to claim 1, wherein the rotor body (10) is additionally divided into a plurality of rotor section groups (28, 30; 50, 52, 54) in at least one radial plain.

3. A rotor arrangement according to claim 2, wherein the rotor sections (32, 34, 36, 38; 60) of adjoining rotor section groups (28, 30; 50, 52, 54) are mounted on the shaft (16) offset at an angle with respect to one another.

4. A rotor arrangement according to claim 1, wherein the rotor sections (12, 14; 32, 34, 36, 38; 60) take the form of semi-cylindrical rotor halves.

5. A rotor arrangement according to claim 4, wherein the rotor body (10) is formed from two rotor halves (12, 14).

6. A rotor arrangement according to claim 4, wherein the rotor body (10) is formed from two rotor-half pairs (28, 30) arranged next to each other along the length of the shaft and mounted on the shaft (16) at an offset of 90° with respect to one another.

7. A rotor arrangement according to claim 4, wherein the rotor body (10) is formed from three rotor-half pairs (50, 52, 54) arranged next to each other along the length of the shaft and mounted on the shaft at an offset of 90° with respect to one another.

8. A rotor arrangement according to claim 1, wherein each rotor section (12, 14; 32, 34, 36, 38; 60) is formed from a stack of laminations.

9. A rotor arrangement according to claim 4, wherein the rotor body (10) is formed from a large number of rotor lamination-half pairs (60) which are arranged next to each other along the length of the shaft (16) and are mounted on the shaft at an offset of 90° with respect to one another.

10. A rotor arrangement according to claim 1, wherein the circumference of the shaft (16) takes the shape of a polygon in the region used to receive the rotor, and the rotor sections are connected to the shaft (16) in this region (18) in a positive fit.

11. A rotor arrangement according to claim 1, wherein the circumference of the shaft (16) substantially takes the shape of an equilateral polygon, particularly a square, in the region (18) used to receive the rotor.

12. A rotor arrangement according to claim 1, wherein the rotor body (10) has recesses (22) to receive permanent magnets.

13. A rotor arrangement according to claim 1, wherein the rotor sections (12, 14; 32, 34, 36, 38; 60) are held together after being connected to the shaft (16) by means of end caps (24, 26; 44, 46), a pipe (42) that is slid over the assembled rotor body (10), or one or more clamping rings (56, 58).

14. A method for manufacturing a rotor arrangement for an electric machine in which a substantially cylindrical rotor body (10) made up of a plurality of substantially identical rotor sections (12, 14; 32, 34, 36, 38, 60) and mounted onto a shaft (16), wherein the rotor laminations are punched out in such a way that they are divided into a plurality of rotor lamination sections in at least one plane containing the axis of the shaft and the rotor lamination sections are connected to the shaft (16) in a positive fit, wherein the circumference of the shaft (16) has at least one region (18) to receive the rotor lamination sections.

15. A method according to claim 14, wherein the circumference of the shaft (16) substantially takes the shape of an equilateral polygon, particularly a square, in the region (18) used to receive the rotor lamination sections.

16. A method according to claim 14, wherein the rotor lamination sections are laminated to form rotor sections (12, 14; 32, 34, 36, 38; 60) before being connected to the shaft (16).

17. A method according to claim 16, wherein the rotor body (10) is made up of a plurality of rotor section groups (28, 30; 50, 52, 24) which lie next to each other in the longitudinal direction of the rotor body (10).

18. A method according to claim 17, wherein the rotor sections (12, 14; 32, 34, 36, 38; 60) of adjoining rotor section groups (28, 30; 50, 52, 24) are mounted on the shaft (16) offset at an angle with respect to one another.

19. A method according to claim 14, wherein the rotor lamination sections (60) or rotor section (12, 14; 32, 34, 36, 38; 60) are held together after being connected to the shaft by means of end caps (24, 26; 44, 46), a pipe (42) that is slid over the assembled rotor body (10) or one or more clamping rings (56, 58).

20. A method for manufacturing a rotor arrangement for an electric machine, the method comprising:
providing a substantially cylindrical rotor body (10) made up of a plurality of substantially identical rotor sections (12, 14, 32, 34, 36, 38, 60);
mounting the cylindrical rotor body (10) onto a shaft (16); and
dividing the rotor sections (12, 14; 32, 34, 36, 38, 60) into a plurality of rotor laminations sections in at least one plane containing an axis of the shaft, the rotor sections connecting to the shaft (16) in a positive fit;
wherein the circumference of the shaft (16) has at least one region (18) to receive the rotor lamination sections.
